(19) United States
(12) Patent Application Publication
(10) Pub. No.: US 2013/0165057 A1
(43) Pub. Date: Jun. 27, 2013

(54) RF TRANSMISSION CIRCUIT AND ELECTRONIC DEVICE AND METHOD FOR SAVING POWER THEREOF

(71) Applicants: YEN-CHING LEE, TAIPEI (TW); SHANG-MING CHIU, TAIPEI (TW)

(72) Inventors: YEN-CHING LEE, TAIPEI (TW); SHANG-MING CHIU, TAIPEI (TW)

(73) Assignee: GETAC TECHNOLOGY CORPORATION, HSINCHU (TW)

(21) Appl. No.: 13/485,460

(22) Filed: May 31, 2012

(30) Foreign Application Priority Data
Dec. 21, 2011 (CN) CN201110431522.3

(51) Int. Cl. H04B 1/44; H04B 7/02

(52) U.S. Cl. 455/83; 455/101

(57) ABSTRACT

A radio frequency (RF) transmission circuit and an electronic device and a method for saving power thereof are provided. The RF transmission circuit includes: an antenna, at least one controller, a first path, a second path and a signal switching unit. The controller generates and/or receives RF signal. The controller has a determination function determining power of the RF signal and a switching function selecting or changing the transmission path of the RF signal as the first path and the second path. The first path transmits the RF signal to the antenna. The second path has a power amplifier to amplify the power of the RF signal and then transmit the amplified RF signal to the antenna. The signal switching unit selectively connects the antenna to the first path or the second path. When the first path is selected, the controller turns off the power amplifier.

### BACKGROUND OF THE INVENTION

1. Field of the Invention

The present invention generally relates to a radio frequency (RF) transmission circuit, and in particular, relates to an RF transmission circuit capable of adaptively selecting a signal transmission path and an electronic device and a method for saving power thereof.

2. Description of Related Art

In recent years, with the development of communication technologies, RF transmission circuits widely applied in communication electronic products has become increasingly important. Generally speaking, in the RF transmission circuit, all transmitted signals must be amplified by a power amplifier before being transmitted through an antenna. However, the power amplifier is an element with high power consumption. In the conventional art, even if signals do not need to be amplified, signals are all amplified through the power amplifier on the transmission path. In this way, when the signals has strong enough signal strength but does not need to be amplified, the RF transmission circuit additionally consumes power on the power amplifier, thereby resulting in unnecessary power consumption. In addition, in order to make the transmitted signals conform to an input range of the power amplifier, the strength of the transmitted signals often needs to be attenuated through a power attenuation unit before amplification. Such power attenuation procedure may cause inefficient power consumption even for the transmitted signals with strong signal strength. In addition, the dynamic range of signal transmission of the RF transmission circuit is also limited by the power amplifier. That is to say, the RF transmission circuit cannot meet the requirements for low-power signal transmission while performing high-power signal transmission; and if low-power signal transmission is performed, the RF transmission circuit cannot meet the requirements for high-power transmission.

### SUMMARY OF THE INVENTION

Accordingly, the present invention is directed to an RF transmission circuit, which includes an antenna, at least one controller, a first path, a second path and a signal switching unit. The at least one controller receives a first RF signal and/or generates a second RF signal, and has a determination function and a switching function, in which the determination function determines power of the first RF signal, and the switching function selects or changes a transmission path of the second RF signal. The first path transmits the second RF signal generated by the controller to the antenna. The second path has a first power amplifier, and the second path amplifies the power of the second RF signal generated by the controller through the first power amplifier, and then the second path transmits the second signal to the antenna. The signal switching unit is electrically connected to the antenna, the first path and the second path respectively, and the signal switching unit selectively connects the antenna to the first path or the second path. The controller determines the power of the first RF signal through the determination function, and selects or changes the first path or the second path through the switching function according to a determination result of the determination function, so as to transmit the second RF signal to the antenna. When the first path is selected, the controller turns off the first power amplifier.

The present invention provides an electronic device having an RF transmission circuit. The RF transmission circuit includes an antenna, at least one controller, a first path, a second path and a signal switching unit. The at least one controller receives a first RF signal and/or generates a second RF signal, and has a determination function and a switching function, in which the determination function determines power of the first RF signal, and the switching function selects or changes a transmission path of the second RF signal. The first path transmits the second RF signal generated by the controller to the antenna. The second path has a first power amplifier, and the second path amplifies, through the first power amplifier, the power of the second RF signal generated by the controller, and then the second path transmits the second RF signal to the antenna. The signal switching unit is electrically connected to the antenna, the first path and the second path respectively, and the signal switching unit selectively connects the antenna to the first path or the second path. The controller determines the power of the first RF signal through the determination function, and selects or changes the first path or the second path through the switching function according to a determination result of the determination function, so as to transmit the second RF signal to the antenna. When the first path is selected, the controller turns off the first power amplifier.

The present invention provides a method for saving power, which is adapted to an RF transmission circuit. The method for saving power includes the following steps: receiving a first RF signal; determining power of the first RF signal; selecting a first path or a second path according to the power of the first RF signal; when the first path is selected, turning off the first power amplifier; when the second path is selected, turning on the first power amplifier; and transmitting the second RF signal to an antenna through the first path or the second path.

In order to make the aforementioned features and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of an RF transmission circuit according to an embodiment of the present invention.

FIG. 2 is a functional block diagram of another RF transmission circuit according to an embodiment of the present invention.

FIG. 3A is a functional block diagram of an electronic device according to an embodiment of the present invention.

FIG. 3B is a schematic diagram of a communication environment of an outdoor wireless network.

FIG. 3C is a schematic diagram of a communication environment of an indoor wireless network.

FIG. 4 is a flowchart according to an embodiment of the present invention.

FIG. 5 is a flowchart according to another embodiment of the present invention.

### DESCRIPTION OF THE EMBODIMENTS

Multiple viewpoints of the present invention have been summarized, and reference is now made to the detailed description of the drawings. The same reference numbers are used in the drawings and the description to refer to the same or like parts. The present invention provides an RF transmission circuit structure, and in some embodiments, the RF transmission circuit structure provided in the present invention can effectively reduce the power consumption of communication electronic products.

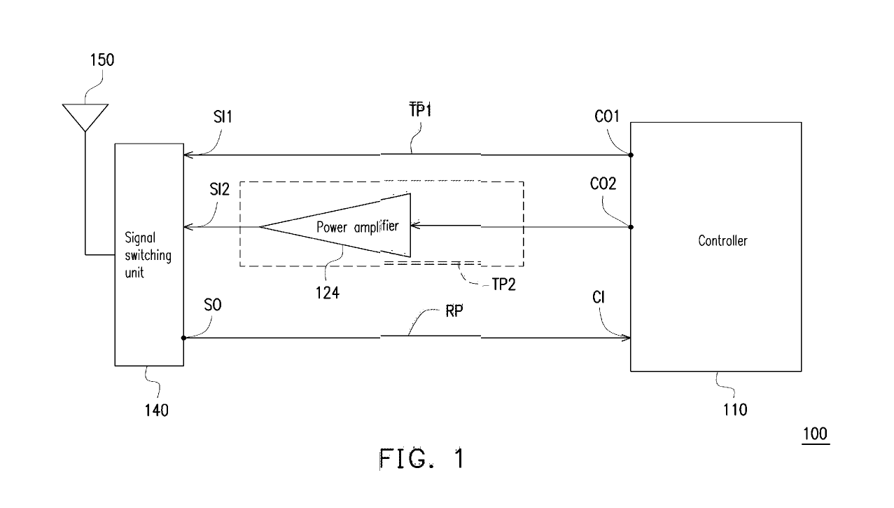

FIG. 1 is a functional block diagram of an RF transmission circuit 100 according to an embodiment of the present invention. The RF transmission circuit 100 as shown in FIG. 1 includes a first path TP1, a second path TP2, a receiving path RP, a controller 110, a signal switching unit 140 and at least one antenna 150. The first path TP1 is connected to a first output end CO1 of the controller 110, and is connected to a first input end SI1 of the signal switching unit 140. The second path TP2 is connected to a second output end CO2 of the controller 110, and is connected to the signal switching unit 140. The receiving path RP is connected to an output end SO of the signal switching unit 140, and is connected to an input end CI of the controller 110.

The signal switching unit 140 is electrically connected to the antenna 150, the first path TP1, the second path TP2 and the receiving path RP respectively, and selectively connects the antenna 150 to one of the first path TP1, the second path TP2 and the receiving path RP. Further, the switching operation of the first path TP1 and the second path TP2 is executed by a path switching function provided by the controller 110. The antenna 150 is configured to transmit and receive RF signal. When the antenna 150 receives a first RF signal, the signal switching unit 140 connects the antenna 150 to the receiving path RP so as to provide the received first RF signal to the controller 110. When the controller 110 needs to transmit a second RF signal to the antenna 150, the signal switching unit 140 selectively connects the antenna 150 to one of the first path TP1 and the second path TP2 so as to provide the second RF signal to the antenna 150.

The RF transmission circuit in the conventional art merely has a single transmission path that is similar to the second path TP2 and has a power amplifier. In contrast, the RF transmission circuit 100 in this embodiment provides an additional first transmission path TP1. An RF signal which has signal strength greater than a preset threshold and does not need to be amplified can be directly transmitted to the signal switching unit 140 through the first path TP1, and then the signal switching unit 140 transmits the RF signal to the antenna 150 for transmission.

Since the first path TP1 does not involve an amplification process of the power amplifier 124, the original power consumption for the unnecessary amplification process can be saved. In addition, the RF transmission circuit 100 can adaptively determine whether to maintain the original power transmission or achieve a high-power transmission effect through the power amplifier by the switching function between the first path and the second path. Meanwhile, compared with the conventional RF transmission circuit, the RF transmission circuit 100 can implement a wider dynamic range of RF signal transmission.

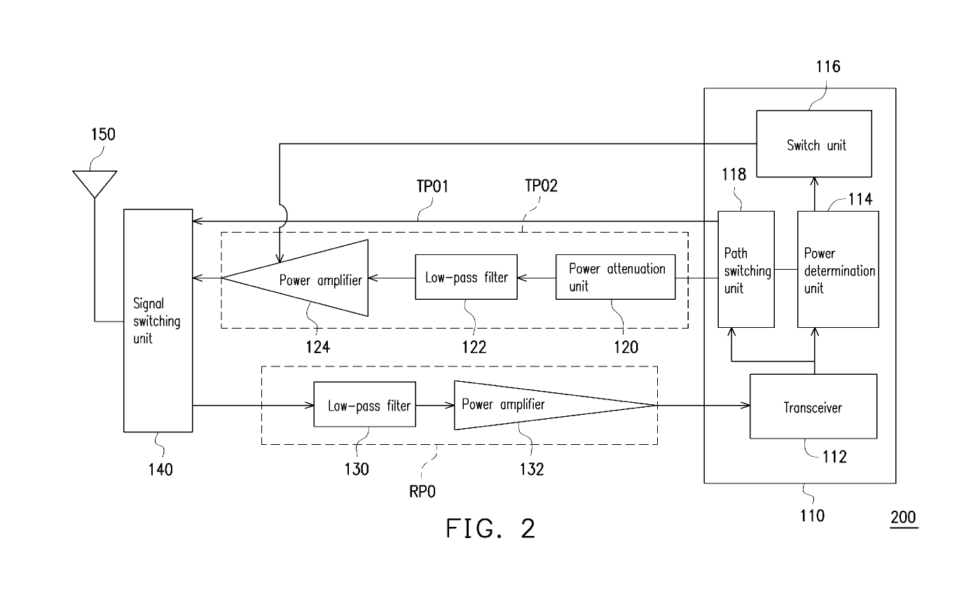

FIG. 2 is a functional block diagram of another RF transmission circuit 200 according to an embodiment of the present invention. Referring to FIG. 2, the RF transmission circuit 200 includes a first path TP01, a second path TP02, a receiving path RP0, a signal switching unit 140, a controller 110 and at least one antenna 150. The controller 110 includes a transceiver 112, a power determination unit 114, a switch unit 116 and a path switching unit 118. The first path TP01 is connected to the path switching unit 118, and is further connected to the signal switching unit 140. The second path TP02 is connected to the path switching unit 118, and is further connected to the signal switching unit 140. The receiving path RP0 is connected to the signal switching unit 140, and is also connected to the transceiver 112.

The signal switching unit 140 is electrically connected to the antenna 150, the first path TP01, the second path TP02 and the receiving path RP0 respectively, and selectively connects the antenna 150 to one of the first path TP01, the second path TP02 and the receiving path RP0. Further, the switching operation of the first path TP01 and the second path TP02 is executed by the path switching unit 118 in the controller 110. The antenna 150 is configured to receive the first RF signal and/or transmit the second RF signal. When the antenna 150 receives the first RF signal, the signal switching unit 140 connects the antenna 150 to the receiving path RP0 so as to provide the received first RF signal to the controller 110. When the controller 110 needs to transmit the second RF signal, the signal switching unit 140 selectively connects the antenna 150 to one of the first path TP1 and the second path TP2 so as to provide the second RF signal from the controller 110 to the antenna 150.

The second path TP02 has a power attenuation unit 120, a low-pass filter 122 and a power amplifier 124. When the transceiver 112 intends to transmit the second RF signal which needs to be amplified, the second RF signal is connected to the second path TP02 through the path switching unit 118. Firstly, an attenuation process is performed on the second RF signal by the power attenuation unit 120 in the second path TP02, so that the second RF signal conforms to an input dynamic range of the power amplifier 124, then the second RF signal sequentially passes through the low-pass filter 122 and the power amplifier 124. Finally, the second RF signal is connected by the signal switching unit 140 to the antenna 150 for transmitting the second RF signal.

The receiving path RP0 has a low-pass filter 130 and a power amplifier 132. When the antenna 150 receives the first RF signal, the signal switching unit 140 connects the antenna 150 to the receiving path RP0. Then, the receiving path RP0 transmits the first RF signal to the transceiver 112 sequentially through the low-pass filter 130 and the power amplifier 132.

Referring to FIG. 2, the transceiver 112 is connected to the power amplifier 132, the power determination unit 114 and the path switching unit 118. The transceiver 112 shown in FIG. 2 is configured to receive the first RF signal received by the antenna 150 through the receiving path RP0, transmit the received first RF signal to the power determination unit 114, and transmit the first RF signal which needs to be transmitted to the path switching unit 118.

The power determination unit 114 is connected to the switch unit 116 and the path switching unit 118, and is configured to determine whether the signal strength of the received first RF signal is greater than a preset threshold to generate a determination result, and then transmit the determination result to the switch unit 116 and the path switching unit 118. That is, the power determination unit 114 executes a determination function of the controller 110.

The switch unit 116 is connected to the power amplifier 124 and is configured to control the power amplifier 124. That is, the switch unit 116 is configured to turn on or turn off the power amplifier 124, according to the received determination result. Alternatively, the power determination unit 114 may also provide a control signal with a first voltage level or a second voltage level to the path switching unit 118 and the switch unit 116. And the path switching unit 118 determines whether to use the first path TP01 or the second path TP02 to transmit the second RF signal according to the control signal. That is, the path switching unit 118 executes the switching function of the controller 110.

Referring to FIG. 2, for example, if the power determination unit 114 determines that the signal strength of the signal received through the receiving path RP0 is greater than a preset threshold, the power determination unit 114 generates a control signal with a first voltage level (for example, corresponding to a logic level “0”), and provides the control signal to the switch unit 116. And the switch unit 116 turns off the power amplifier 124 according to the first voltage level, so as to reduce power consumption. Through the control signal with the first voltage level, the power determination unit 114 may further control the path switching unit 118 to select the first path TP01 to transmit the signal. If the power determination unit 114 determines that the signal strength of the first RF signal received through the receiving path RP0 is less than or equal to the preset threshold, the power determination unit 114 generates a control signal with a second voltage level (for example, corresponding to a logic level “1”), and provides the control signal to the path switching unit 118 to select the second path TP02 to transmit the second RF signal. Through the control signal with the second voltage level, the power determination unit 114 may further control the switch unit 116 to turn on the power amplifier 124, so as to amplify the second RF signal in the second path TP02.

Further, operation modes of the path switching unit 118 may be classified as “select” mode and “change” mode. In an embodiment, when the “select” mode is performed, the path switching unit 118 can directly determine that the first path TP01 or the second path TP02 transmits the second RF signal (which needs to be transmitted) to the antenna 150 according to the voltage level in the determination result output by the power determination unit 114. For example, when the power determination unit 114 outputs a control signal with a logic level “0” to the path switching unit 118, the patch switching unit 118 selects the first path TP01; and when the power determination unit 114 outputs a control signal with a logic level “1” to the path switching unit 118, the patch switching unit 118 selects the second path TP02.

In another embodiment in which the “change” mode is performed, the operation mode of the path switching unit 118 changes to determine whether to change the original path for transmitting the signal according to the voltage level input by the power determination unit 114. For example, when the power determination unit 114 outputs a control signal with a logic level “0” to the path switching unit 118, the path switching unit 118 maintains the currently selected path (for example, the first path TP01); and when the power determination unit 114 outputs a control signal with a logic level “1” to the path switching unit 118, the path switching unit 118 changes the current path to the other path (for example, changes the first path TP01 to the second path TP02).

Alternatively, when the currently selected path of the path switching unit 118 is the second path TP02, and the power determination unit 114 outputs a control signal with a logic level “0” to the path switching unit 118, the path switching unit 118 may maintain the currently selected path (that is, the second path TP02); and when the power determination unit 114 outputs a control signal with a logic level “1” to the path switching unit 118, the path switching unit 118 changes the current path to the other path (that is, changes the second path TP02 to the first path TP01).

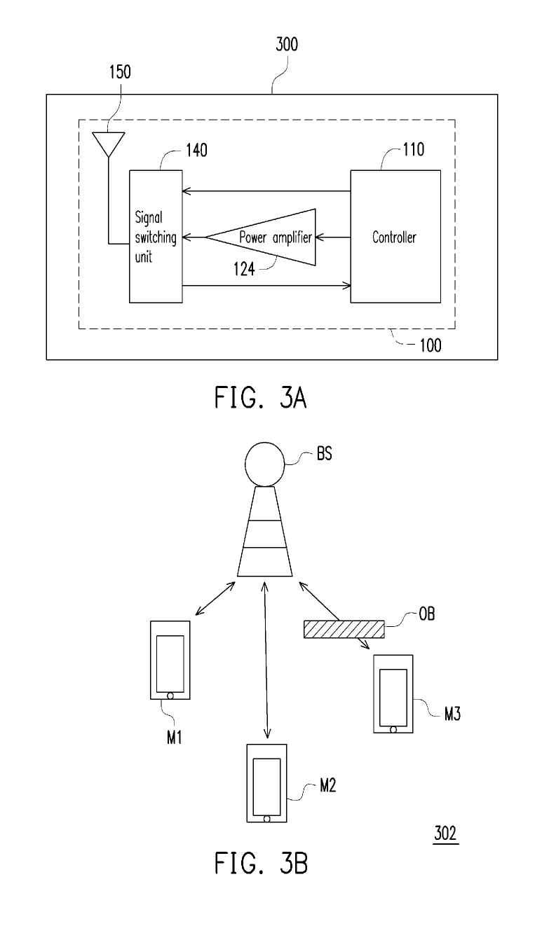

FIG. 3A is a functional block diagram of an electronic device according to an embodiment of the present invention. Referring to FIG. 3A, the electronic device 300 includes the RF transmission circuit 100 shown in FIG. 1, and the technical contents of the RF transmission circuit 100 can be referred to FIG. 1 and the corresponding contents in the specification, so the details thereof are not described herein. The electronic device 300 may be specifically implemented as a wireless transmission device, such as a smart phone, a personal digital assistant (PDA), a notebook computer, a tablet computer and a Bluetooth device, but the implementations of the present invention is not limited thereto.

FIG. 3B and FIG. 3C are respectively schematic diagrams of a communication environment 302 of an outdoor wireless network and a communication environment 304 of an indoor wireless network. Referring to FIG. 3B, the wireless network communication environment 302 includes smart phones M1-M4, and the users use the smart phones M1 -M4 to connect to the wireless network, where the communication connection may be performed through a base station BS provided by a telecommunication operator in FIG. 3B or a wireless network access point AP in a building in FIG. 3C. Each of the smart phones M1-M4 has the built-in RF transmission circuit 100.

Referring to FIG. 3B, when the smart phone M1 is close to the base station BS with which the smart phone M1 communicates, the communication quality can generally be guaranteed without requiring too strong transmitting RF signal strength. At this time, the transmitting RF signal may be transmitted through the first path TP1 provided by the built-in RF transmission circuit 100 of the smart phone M1, thereby reducing the power consumption. For another example, when the smart phones M2 and M3 are respectively located at a place far from the base station BS and a place shielded by an obstruction object OB, the communication quality thereof may be degraded accordingly. At this time, the signal transmission path may be automatically adjusted as the second path TP2 through the built-in RF transmission circuits 100 of the smart phones M2 and M3, so as to amplify the weak transmitting RF signal to maintain the communication quality. This embodiment can also be applicable to the case of making a telephone call through a cellular communication system, but the implementation manner is not limited thereto.

Referring to FIG. 3C, when the smart phone M4 is connected to the wireless network through the wireless network access point AP in the building, the smart phone M4 is usually not far from the network access point AP. At this time, the transmission path for the transmitting RF signal of the RF transmission circuit 100 in the smart phone M4 may be adjusted as the first path TP1 to save power. Similarly, when an obstruction object exists between the smart phone M4 and the wireless network access point AP and this situation leads to the degraded communication quality, the RF transmission circuit 100 may automatically adjust the transmission path as the second path TP2 so as to amplify the weak transmitting RF signal to maintain the communication quality.

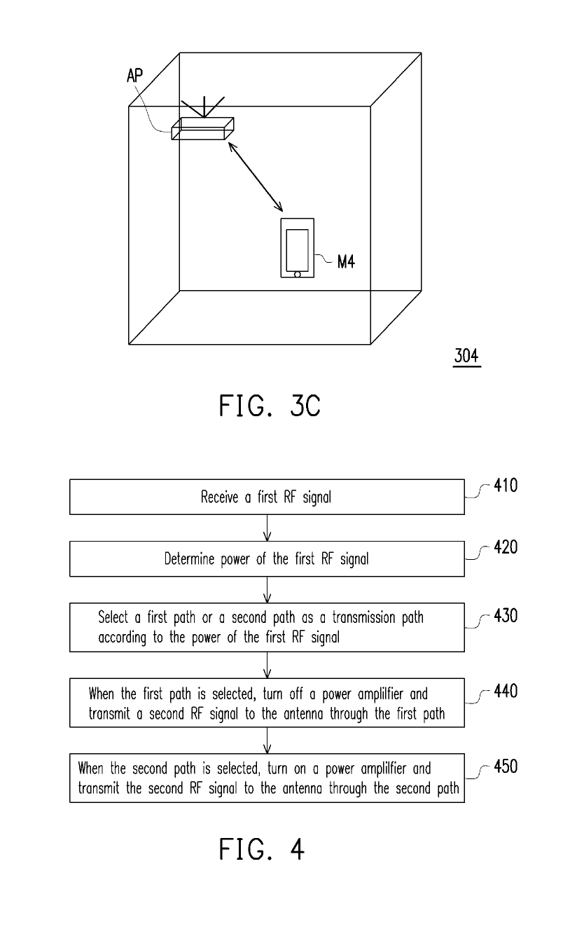

FIG. 4 is a flowchart of a method for saving power, which is applicable to an RF transmission circuit according to an embodiment of the present invention. As shown in FIG. 4, the method for saving power includes the following steps. The method for saving power of the present embodiment may be applied in the architecture of FIG. 1.

In step 410, a first RF signal is received. In step 420, power of the first RF signal is determined. In step 430, selecting the first path or the second path in the RF transmission circuit as the transmission path is performed according to the power of the first RF signal, in which the first path and the second path are two transmission paths configured to transmit a second RF signal output by the controller to the antenna in the RF transmission circuit. The second path has a power amplifier, and the originally preset RF signal transmission path is the second path. In step 440, when the first path is selected (that is, the RF signal transmission path is changed from the second path to the first path), the power amplifier is turned off and the second RF signal is transmitted to the antenna through the first path. In step 450, when the second path is selected (that is, the RF signal transmission path is changed from the first path to the second path), the power amplifier in the second path is turned on, and the second RF signal is transmitted to the antenna through the second path.

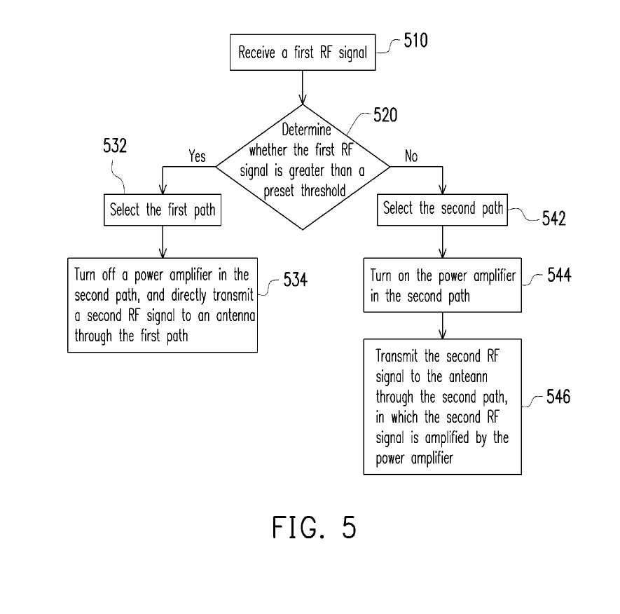

FIG. 5 is a flow chart of another method for saving power applicable to an RF transmission circuit according to an embodiment of the present invention.

In step 510, a first RF signal is received. In step 520, power of a first RF signal is determined, and it is further determined whether the power of the first RF signal is greater than a preset threshold. In the step 520, when it is determined that the first RF signal is greater than the threshold, step 532 is performed after the step 520; and when it is determined that the first RF signal is less than or equal to the threshold, step 542 is preformed after the step 520.

Since the first path is selected to transmit the second RF signal to an antenna in the step 532, in step 534, a power amplifier in the second path is turned off, and the second RF signal is directly transmitted to an antenna through the first path, so as to reduce power consumption of the power amplifier.

Since the second path is selected to transmit the second RF signal to the antenna in the step 542, in the step 544, the power amplifier in the second path is turned on. Afterwards, in step 546, the RF signal is transmitted to the antenna through the second path, in which the RF signal is amplified by the power amplifier.

In summary, the present invention provides an RF transmission circuit and an electronic device and a method for saving power thereof. Compared with an RF transmission circuit with a single signal transmission path in the conventional art, the RF circuit provides an additional RF signal transmission path, and an RF signal which does not need to be amplified can be directly transmitted to the antenna for transmission through the additional RF signal transmission path. Moreover, power originally consumed for the unnecessary power amplification procedure can be saved by adaptively turning on or turning off the power amplifier, so as to achieve the effect of saving the power. A transmitted signal with signal strength which does not need to be amplified still can be transmitted through the RF signal transmission path having the power amplifier and can be amplified by the power amplifier before transmission. In this way, the RF transmission circuit can meet the requirements for high-power and low-power RF signal transmission, and also widen the dynamic range of signal transmission by adaptively selecting the transmission path.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A radio frequency (RF) transmission circuit, comprising:
an antenna;
at least one controller, configured to receive a first RF signal and/or generate a second RF signal, and having a determination function and a switching function, wherein the determination function determines power of the first RF signal, and the switching function selects or changes a transmission path of the second RF signal;
a first path, configured to transmit the second RF signal generated by the controller to the antenna;
a second path, having a first power amplifier, wherein the second path amplifies the power of the second RF signal generated by the controller through the first power amplifier, and then transmits the second RF signal to the antenna; and
a signal switching unit, electrically connected to the antenna, the first path and the second path respectively, wherein the signal switching unit selectively connects the antenna to the first path or the second path,
wherein the controller determines the power of the first RF signal through the determination function, and the controller selects or changes the first path or the second path through the switching function according to a determination result of the determination function to transmit the second RF signal to the antenna, and when the first path is selected, the controller turns off the first power amplifier.

2. The RF transmission circuit according to claim 1, wherein a function of the controller configured to generate the second RF signal and/or receive the first RF signal is executed by a transceiver.

3. The RF transmission circuit according to claim 1, wherein the determination function of the controller is executed by a power determination unit.

4. The RF transmission circuit according to claim 1, wherein the switching function of the controller is executed by a path switching unit.

5. The RF transmission circuit according to claim 1, wherein a function of the controller configured to turn off the first power amplifier is executed by a switch unit.

6. The RF transmission circuit according to claim 1, wherein when the second path is selected, the first power amplifier is turned on.

7. The RF transmission circuit according to claim 3, wherein
when the power determination unit determines that the power of the first RF signal is greater than a preset threshold, a control signal with a first voltage level is generated by the power determination unit; and
when the power determination unit determines that the power of the first RF signal is less than or equal to the preset threshold, a control signal with a second voltage level is generated by the power determination unit.

8. The RF transmission circuit according to claim 1, wherein the second path comprises a power attenuation unit.

9. The RF transmission circuit according to claim 1, wherein the second path comprises a low-pass filter.

10. The RF transmission circuit according to claim 1, wherein a receiving path is allocated between the signal switching unit and the controller, and the first RF signal received by the antenna is transmitted to the controller through the receiving path.

11. The RF transmission circuit according to claim 10, wherein the receiving path comprises a low-pass filter.

12. The RF transmission circuit according to claim 10, wherein the receiving path comprises a second power amplifier, the second power amplifier amplifies the power of the first RF signal received by the antenna, and then the receiving path outputs the first RF signal to the controller.

13. An electronic device, having a radio frequency (RF) transmission circuit, wherein the RF transmission circuit comprises:
an antenna;
at least one controller, configured to receive a first RF signal and/or generate a second RF signal, and having a determination function and a switching function, wherein the determination function determines power of the first RF signal, and the switching function selects or changes a transmission path of the second RF signal;
a first path, configured to transmit the second RF signal generated by the controller to the antenna;
a second path, having a first power amplifier, wherein the second path amplifies the power of the second RF signal generated by the controller through the first power amplifier, and then transmits the second signal to the antenna;
a signal switching unit, electrically connected to the antenna, the first path and the second path respectively, wherein the signal switching unit selectively connects the antenna to the first path or the second path; and
wherein the controller determines the power of the first RF signal through the determination function, and the controller selects or changes the first path or the second path through the switching function according to a determination result of the determination function to transmit the second RF signal to the antenna, and when the first path is selected, the controller turns off the first power amplifier.

14. A method for saving power, adapted to a radio frequency (RF) transmission circuit, the method for saving power comprising:
receiving a first RF signal;
determining power of the first RF signal;
selecting a first path or a second path as a transmission path of a second RF signal according to the power of the first RF signal;
when the first path is selected, turning off a power amplifier in the second path;
when the second path is selected, turning on the power amplifier; and
transmitting the second RF signal to an antenna through the first path or the second path.

15. The method for saving power according to claim 14, wherein the step of transmitting the second RF signal to the antenna through the first path or the second path comprises:
when the first path is selected, directly transmitting the second RF signal to the antenna through the first path; and
when the second path is selected, amplifying the second RF signal through the power amplifier, and then transmitting the amplified second RF signal to the antenna through the second path.

16. The method for saving power according to claim 14, wherein the step of switching to the first path or the second path according to the power of the first RF signal comprises:
selecting, according to the power of the first RF signal, one of the first path and the second path to transmit the second RF signal.

17. The method for saving power according to claim 14, further comprising:
determining whether to turn on or turn off the power amplifier in the second path according to the power of the first RF signal.
